(19) United States
(12) Patent Application Publication
(10) Pub. No.: US 2003/0123895 A1
(43) Pub. Date: Jul. 3, 2003

(54) Paper discharging mechanism of image forming apparatus

(75) Inventor: Mitsunori Ishii, Tokyo (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/028,446

(22) Filed: Dec. 28, 2001

(51) Int. Cl. G03G 15/00

(52) U.S. Cl. 399/82

(57) ABSTRACT

A paper discharging mechanism of an image forming apparatus of this invention has paper discharging trays at plural stages to discharge paper on which images are formed by an image forming apparatus in order from newer image forming jobs, an accumulation device to accumulate paper that are discharged from the paper discharging trays at plural stages, a paper moving devices to take out paper housed in the paper discharging trays at plural stages and move into an accumulating device, and a controller to control the paper moving device so as to take out paper from the paper discharging devices in order from older image forming jobs. Thus, paper that are stayed in the paper discharging trays for a long time are shunted and empty paper discharging trays are secured for paper discharged according to image forming jobs.

### BACKGROUND OF THE INVENTION

1. Field of the Invention

The present invention relates to a paper discharging mechanism of an image forming apparatus for sorting and discharging image formed paper by a copier, a personal computer (called as PC) terminal or a facsimile, etc. by classifying for each image forming job.

2. Description of the Related Art

In the case of an image forming apparatus of a digital composite apparatus that is used commonly by plural users as a copier, PC terminal or facsimile through a network line or telephone line such as a local area network (hereinafter, referred to as LAN), a paper discharging mechanism which has plural paper trays for sorting and discharging paper into each paper discharging trays for respective image forming jobs is generally provided. After executing an image forming job from own desk, each user proceeds to an area where an image forming apparatus is installed at an optional timing and brings back image formed paper discharged in a paper discharging tray.

As such a paper discharging mechanism of an image forming apparatus, there is a paper discharging mechanism of which plural paper discharging trays that are used commonly by all of many users without designating an individual paper discharging tray for each user. In such a paper discharging mechanism of which plural paper discharging trays are commonly used by all of many users, paper are kept retained in the paper discharging trays for a long hour because users come late or forget to pick up them or in the case of facsimile images, users did not know the receiving of FAX paper and didn't come to take up the FAX paper.

However, the existing paper discharging mechanism has not a function to process paper that are kept retained in the paper discharging trays for a long hour. As a result, paper retained in the trays for long hours are accumulated. Therefore, when it became necessary to remove accumulated paper, user had to go to a place where an image forming apparatus was installed, and rearrange the trays by manually taking paper out of the paper discharging tray and moving them into a storage box. Furthermore, such the manual rearrangement of the paper discharging trays by users became frequent and retention of paper in the discharging trays tends to be unavoidable irrespective of the removing process when it becomes necessary.

Accordingly, in a paper discharging mechanism of an image forming apparatus of which paper discharging trays are used commonly by many users, it is desired to be capable of removing paper accumulated in the discharging trays without troubling users, smoothly discharging paper and obtaining high operability. Further, it is also necessary to urge an individual user to process print paper surely.

### SUMMARY OF THE INVENTION

An object of this invention is to provide a paper discharging mechanism that is capable of smoothly discharging paper from an image forming apparatus without troubling users for removing paper accumulated in paper discharging trays of the discharging mechanism for long hours and obtaining high operability when an image forming apparatus is used commonly by many users.

According to the embodiments of this invention, a paper discharging mechanism of an image forming apparatus is provided. This paper discharging mechanism comprises: paper housing devices at plural stages to house paper on which images are formed by the image forming apparatus in order from newer image forming jobs; an accumulating device to accumulate the paper discharged from the paper housing devices at plural stages; a paper moving device to take out the paper housed in the paper housing devices at plural stages and move them into the accumulation device; and a controller to control the paper moving device so as to take out the paper in order from the older image forming jobs.

Further, according to the embodiments of this invention, a paper discharging mechanism of an image forming apparatus is provided. This paper discharging mechanism comprises: paper discharging devices to house paper on which images are formed by the image forming apparatus in the upper stages in order from newer image forming jobs; an accumulating device to accumulate the paper discharged from the paper discharging trays at plural stages; a paper moving device to take out the paper housed in the paper discharging trays at plural stages and move them into the accumulation device; and a controller to control the paper moving device so as to take the paper out of the paper discharging trays in order from the older image forming jobs.

### BRIEF DESCRIPTION OF THE DRAWINGS

FIG. 1 is a schematic diagram showing a digital composite apparatus and a paper discharging mechanism in a first embodiment of this invention;

FIG. 2 is a schematic diagram showing a paper discharging tray unit in the first embodiment of this invention;

FIG. 3 is a schematic explanation diagram showing the paper taking out in an paper discharging tray in the first embodiment of this invention;

FIG. 4 is a schematic explanation diagram showing the paper falling-into the paper discharging tray at the lower stage in the first embodiment of this invention;

FIG. 5 is a schematic explanation diagram showing the paper taking out in the paper discharging tray by conveying rollers in the first embodiment of this invention;

FIG. 6 is a block diagram of a control system of a digital composite apparatus and the paper discharging mechanism in the first embodiment of this invention;

FIG. 7 is a first flowchart of the first embodiment of this invention;

FIG. 8 is a second flowchart of the first embodiment of this invention;

FIG. 9 is a third flowchart of the first embodiment of this invention;

FIG. 10 is a fourth flowchart of the first embodiment of this invention; and

FIG. 11 is a fifth flowchart of a second embodiment of this invention.

### DETAILED DESCRIPTION OF THE INVENTION

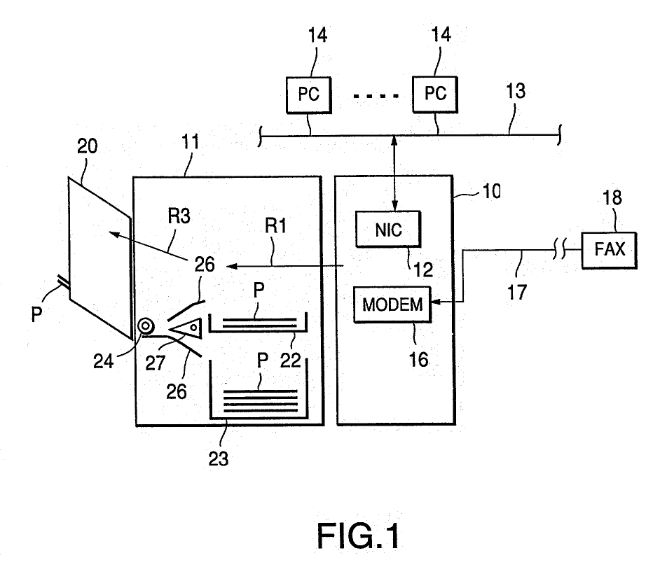

Embodiments of this invention will be explained in detail referring to the attached drawings. FIG. 1 is a schematic diagram showing a digital composite apparatus 10 that is an image forming apparatus and a sorter 11 that is a paper discharging mechanism of the digital composite apparatus 10 in a first embodiment of this invention. The digital composite apparatus 10 has an ordinary copier function and a printer function to form an image on paper P according to image data provided from plural PCs 14 that are connected to a LAN 13 via a Network Interface Card (hereinafter referred to as NIC) 12 and further, a facsimile function to form images on paper P according to image data from a facsimile 18 that is connected to a telephone line 17 via a modem 16, and processes image forming jobs according to information provided from plural users.

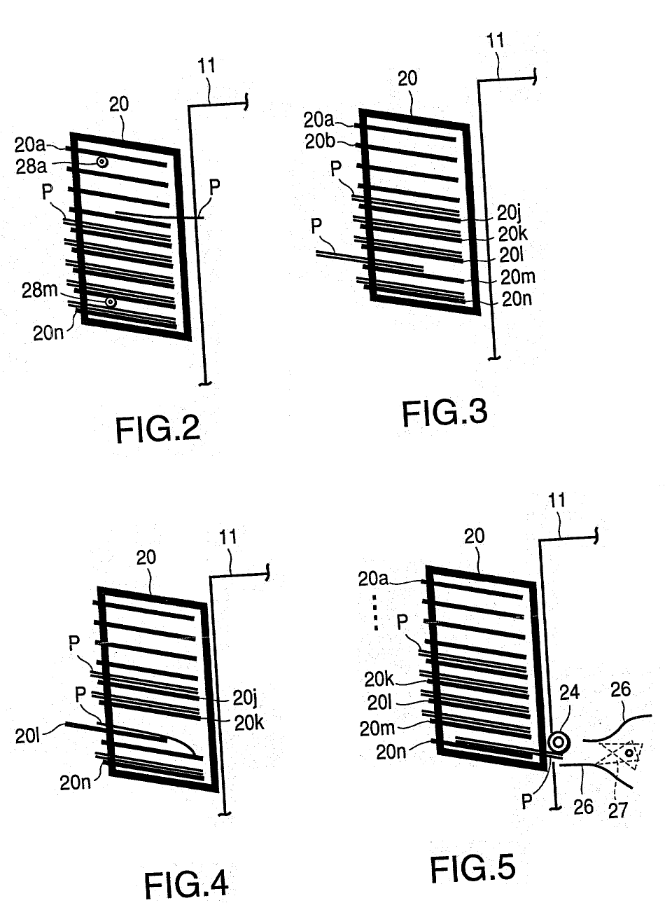

On the side wall of a sorter 11, there is a paper discharging tray unit comprising plural paper discharging trays 20a-20n which are paper housing devices and vertically movable by sliding. Image formed paper P processed in the digital composite apparatus 10 passes through the ordinary paper discharging path shown by the arrows R1 and R2 and discharged into upper empty paper discharging tray always from the paper discharging tray 20n at the lowest stage in order as shown in FIG. 2 regardless of facsimile paper or other printer paper. Thus, a paper processed according to the most new image forming job is always kept on the top. Then, as shown in FIG. 3, it becomes always possible for user to take out image formed paper in any paper discharging trays 20a-20n.

The paper discharging trays 20a-20m excepting the discharging tray at the lowest stage are movable outward of the paper discharging tray unit 20. In order to fill emptied paper discharging trays in the middle as a result of paper taken out by users, the paper discharging trays 20a-20m slide in order from the paper discharging trays 20a-20n along a guide rail (not shown) formed on the inner wall of the paper discharging tray unit 20 by tray moving rollers 28a-28m that are paper falling devices provided to the paper discharging tray unit 20 as shown in FIG. 4. Thus, paper P housed in the upper paper discharging tray above the emptied paper discharging tray at the middle is brought down to the paper discharging tray at lower stage sequentially and fills the empty tray. Further, the paper discharging tray unit 20 has a paper detecting switch (not shown) for detecting presence of paper P in the paper discharging trays 20a-20m.

In the sorter 11, a storage box 22 which is an accumulating and storing device and a shunt box 23 which is a shunting and accumulating device are housed. Further, a conveying roller 24 and a conveying guide 26 for taking out paper P in the paper discharging trays 20a-20n and conveying them toward the storage box 22 or the shunt box 23, and a separator 27 for sorting paper P to the storage box 22 or the shunting box 23 are provided in the sorter 11. Paper P sent to the shunting box 23 is assumed that they will be scrapped.

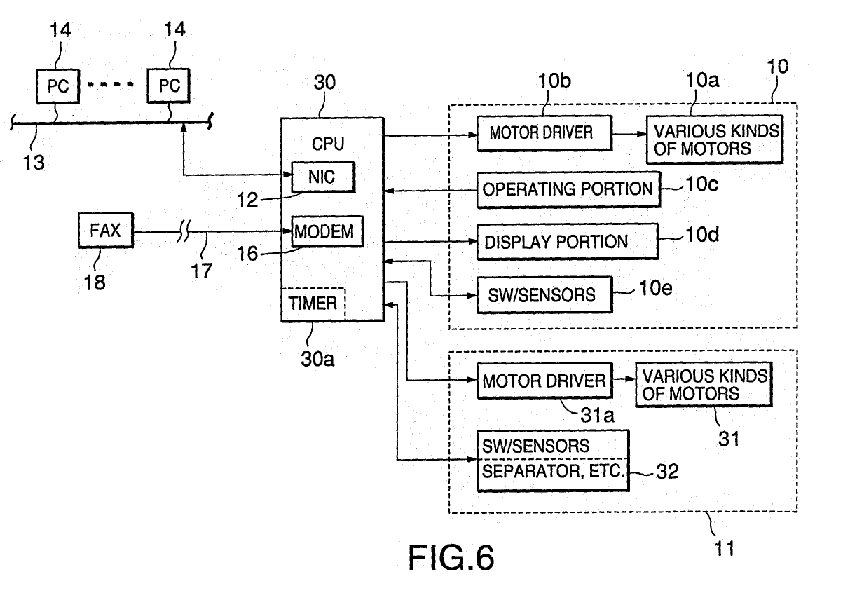

Next, FIG. 6 shows the system structure of the control system of the digital composite apparatus 10 and the sorter 11. A CPU 30 is a controller to control the entire operation of the digital composite apparatus 10 and incorporates a timer 30a, an NIC 12 and a modem 16. A motor driver 10b of various motors 10a for driving a photosensitive drum, developing rollers, etc. a control portion 10 of a ten-key, a copy key, a display portion 10d, and switches/sensors 10e for detecting various operation timings, etc. of the digital composite apparatus 10 are connected to the CPU 30.;

Various motors 31 for driving the conveying rollers (not shown) for conveying paper P discharged from the digital composite apparatus 10, a sliding device for moving vertically the paper discharging tray unit 20 by sliding them (not shown), the conveying roller 24 and tray moving rollers 28a-28m, etc. are connected to the CPU 30 via a motor driver 31a, and further, the separator 27 and switches/sensors 32 including paper detecting switch, etc. are connected to the CPU 30.

Further, the LAN 13 is connected to the NIC 12 of the CPU 30 for connecting multiple PCs 14 and the telephone line 17 is connected to the model 16 for connecting the external facsimile 18, etc.

Next, the operations will be described. When paper P are discharged from the specified image forming job of the digital composite apparatus 10 based on image data provided from users through the PC 14 or the facsimile 18 or an ordinary copying operation, the sorter 11 discharges paper from new image forming jobs in order of image forming jobs into the paper discharging trays 20a-20n from the most low stage to the upper stage and stores image formed paper for each image forming job for temporarily. Paper P by the newest image forming job are always housed in the highest and easy-to-look paper discharging tray as shown in FIG. 2.

During this period, when a user takes out own paper P and the paper discharging tray 20m in the middle is emptied as shown in FIG. 3, slide the paper discharging trays 20j-20l that are housing paper P and are above the emptied tray and move the paper P into the paper discharging trays 20b-20n at the lower stages in order and execute the rearranging work of the trays so as to fill the empty paper discharging tray in the middle as shown in FIG. 4. Thus, paper P are always housed in the paper discharging trays 20a-20n from the lowest stage discharge tray in order of newly generated image forming job in the state separated from other paper P, and the most new paper P are housed in the paper discharging tray that is most easy for user to look at so that user takes out own paper easily.

Further,

(1) When all paper discharging trays 20a-20n including the paper discharging tray 20a at the top stair are full, and the image forming job is further demanded but there is no empty paper discharging tray.

(2) When users came late or forgot to pick up paper or paper became unnecessary and a time of paper P staying in the discharge trays 20a-20n exceeded a preset time.

(3) When the forced shunting is directed by a user who directed an image forming after processing the image forming job.

(4) When the digital composite apparatus is shutdown by turning the power source off.

In the above cases, when the paper in the paper discharging trays 20a-20n are taken out by the conveying roller 24 or when FAX information is formed thereon and in particular, designated for storage by a user, the paper P are sorted to the storage box 22 side by the separator 27 and in the other case the paper P are sorted to the shunting box 23 by the separator 27. In the case of above (1), after this shunting work, users are notified of the shunting work via the NIC 12. In the case of (2), users are notified of the shunting work in advance and after passing the shunting work time, the shunting work is performed and users are notified of the completion of the shunting work.

Further, in the case of (3), when performing the shunting work, using an IP address, a computer name and log-in information, it is checked whether a user who directed the forced shunting is the same user who directed the image forming job and the work is executed.

In the cases of above (1) and (2), the shunting work of the paper P in the lowest stage of the paper discharging tray 20n is executed. In the case of above (3), when the paper discharging tray unit 20 is slid, the prescribed paper discharging trays 20a-20n wherein the image forming job paper P made by a user are stored are slid to the position of the conveying roller 24, the paper P are taken out of the specified discharge tray and the shunting work is executed to sort them to the shunting box 23. In the case of the above (4), when the paper discharging tray 20 is moved, all discharge trays 20a-20n housing discharged paper P are slid to the position of the conveying roller 24 in order, the paper P are taken out of each discharging tray and sorted to the storage box 22 or the shunting box 23.

Thus, the paper P in the trays left by user as the user forgot to take out when completing the work can be solved without troubling the user. Further, in the cases of (1) and (2), all paper P in the paper discharge tray 20n at the lowest stage are subject to the shunting work. Further, in the case of (3), unnecessary paper P in the designated discharging trays at the middle stage are subject to the shunting work. In the case of (4), when paper discharging trays are subject to the shunting work when the apparatus is shut down.

Further, when the image forming job is using a facsimile, it is difficult to specify a user to take up paper P in many cases and a user who should take over paper P is not aware of it in many cases and therefore, facsimile paper are moved in the storage box 22 separating from other paper. Further, the paper P moved into the shunting box 23 is based on the assumption that they will be discarded. These paper are taken out of the discharging tray unit 20, piled up in order and when a specified time is elapsed or the shunting box 23 is filled fully, the paper are discarded by a managing person or an end user. Further, a user who came to take out the paper P after the shunting work has to search the required paper P from the shunting box 23. On the other hand, the paper P containing FAX information are delivered to users who should take them after confirmed by a managing person, etc. after passing a proper time. Then, when paper P are left because persons who should take up the paper are unknown, all users are warned through the NIC 12 and urged to take those paper P.

Further, even in the case of a single image forming job by the same user, when voluminous quantity of paper P are discharged and not housed in a single discharge tray, plural discharge trays can be used when necessary. In this case, the shunting work is made collectively for a single image forming job, and plural discharge trays that are used are regarded as a single discharging tray and the shunting work of all discharging trays that are used for the single image forming job is executed.

Further, set-up conditions such as time, requirement for advance notice, etc. when executing the shunting work are reset at a specified initialization when the power source is turned on.

However, the conditions can be changed directly by a managing person who executes the daily management of the digital composite apparatus 10. Further, when the set-up conditions are directly changed, the conditions are cleared when the power source is turned off when the work is terminated.

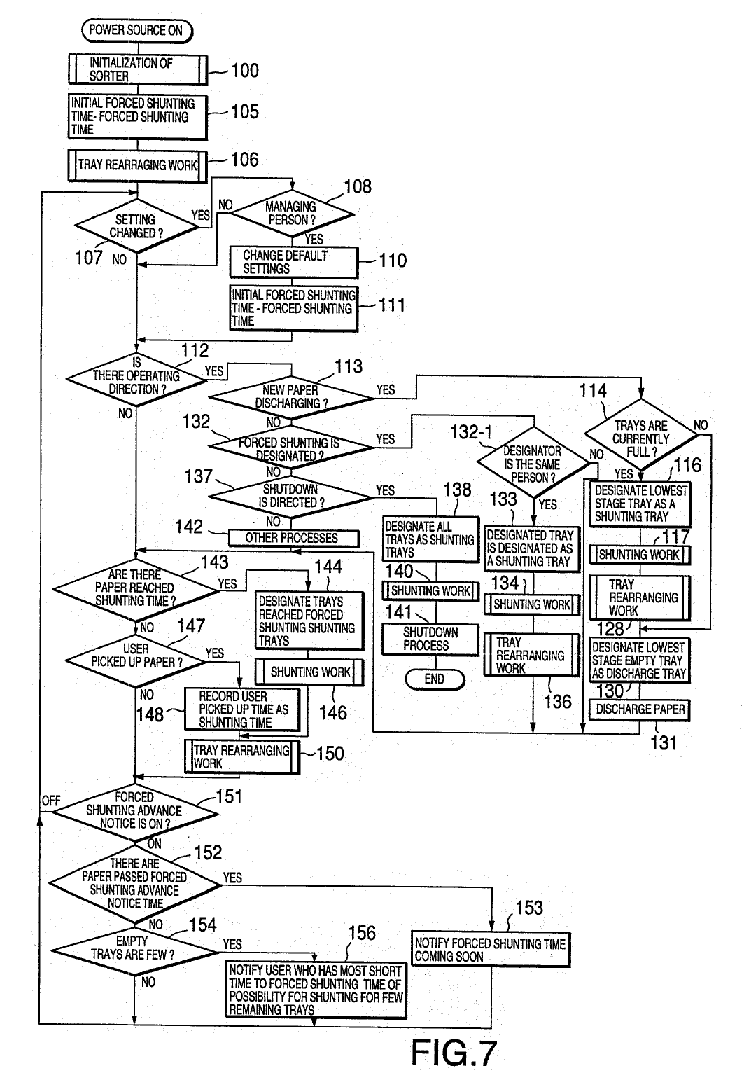

Next, the operation of the above-mentioned sorter will be described in detail referring to the first through fourth flowcharts shown in FIG. 7-FIG. 10. First, when the power source is turned on, the sorter 11 is initialized in Step 100. That is, in Step 101 shown in the third flowchart in FIG. 9, the CPU 30 is set at pre-determined “DEFAULT” condition which are the initial conditions, that is, upper shunting limit, lower shunting limit, initial forced shunting time, propriety of automatic setting change, forced shunting advance notice setting and forced shunting advance notice time, and in Step 102, the timer 30a is initialized.

Then, when a paper detecting switch (not shown) detects that paper P are discharged into the paper discharging trays 20a-20n in Step 103, the timer count of a tray into which paper P are discharged is started and the initialization of the sorter 11 is completed and turns to Step 105. This paper detection when the power source is turned on can be made when paper in the trays 20a-20n cannot be shunted when the system composite apparatus 10 is shut off by the sudden power off such as breaker down, etc. and when paper are abruptly inserted into the paper discharging trays 20a-20n from the outside during the apparatus 10 is stopped.

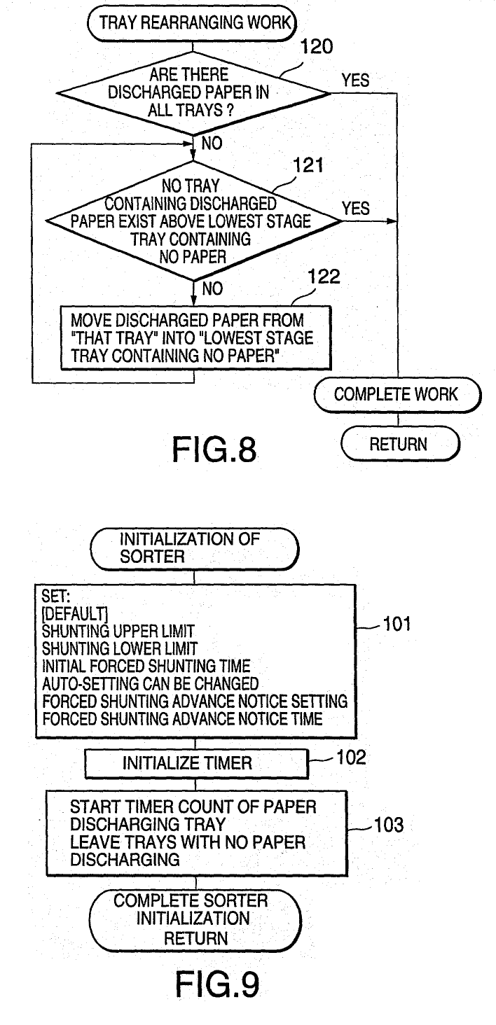

In Step 105, an initial forced shunting time that is preset by a managing person is set as a forced shunting time and in Step 106, if there are any empty trays in the middle, the trays are rearranged to fill the empty trays. When all trays are filled with paper, the rearranging work is terminated in Step 120 shown in the second flowchart in FIG. 8. When an empty tray is generated in the trays 20a-20n, the operation proceeds to Step 121 and when there is an empty tray is generated in the middle and there are paper P in a tray above the empty tray, the operation proceeds to Step 122. When there is no empty tray in the middle, the rearranging work is terminated. In Step 122, paper P in a tray above the empty tray are moved in order into a tray at the lower stage to fill it.

Next, in Step 107, whether there is a setting changing request is checked. When the setting change is requested, proceed to Step 108. If the request is made by a managing person, the “DEFAULT” settings are changed to the requested contents in Step 110 and reset to the forced shunting time in Step 111 and the operation proceeds to Step 112.

When the instruction to the sorter 11 in Step 112 is judged the new paper P discharge from the digital composite apparatus 10 in Step 113, the operation proceeds to Step 114. When the trays 20a-20n are full, the lowest discharge tray 20n is designated as a shunting tray in Step 116. Then, the shunting work is executed in Step 117.

In this shunting work, the discharging trays 20a-20n are scanned from the lower trays to the upper trays in Step 118. When the trays are checked for shunting in Step 220 and there is no tray requiring the shunting and the trays up to the top tray are scanned in Step 118, the shunting work is terminated. When there is any discharging tray requiring the shunting in Step 220, the operation proceeds to Step 221. When paper P are FAX paper or designated by users for storage in Step 221, after moving paper P into the storage box 22 in Step 222, the shunting work is notified if possible in Step 223. When the paper P are not FAX paper or not designated for storage by user in Step 221, after moving the paper P into the shunting box 23 in Step 226, the shunting work is notified if possible in Step 227. Then, when the scanning is completed up to the top tray in Step 118a, the shunting work is terminated.

After completing the shunting work, proceed to Step 128, execute the rearranging work of the paper discharging trays according to the second flowchart shown in FIG. 8, designate the lowest paper discharging tray of the empty paper discharging trays 20a-20n in Step 130, and discharge paper P in the designated paper discharging tray in Step 131.

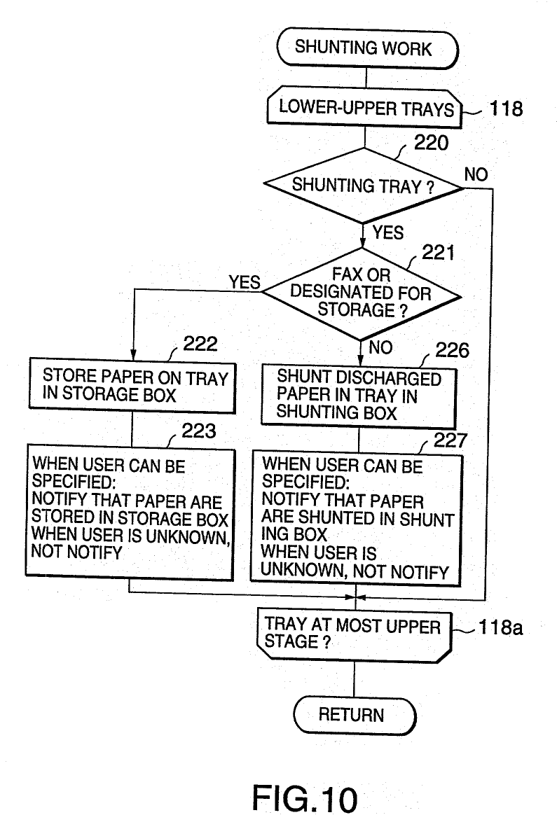

When the instruction to the sorter 11 in Step 112 is found as a forced shunting direction from a user who directed the image forming job, it is checked whether a person who directed the printing in Step 132-1 is the same as a person who directed the forced shunting. When both persons who directed are the same person, proceed to Step 133, designate the specified discharging tray designated by a user as a shunting tray, execute the shunting work according to the fourth flowchart in FIG. 10 in Step 134, go to Step 136, executes the tray rearranging work according to the second flowchart shown in FIG. 8. When the person who directed the printing in Step 132-1 and the person who directing the forced shunting differ, proceeds to Step 143.

When the operating instruction to the sorter 11 in Step 112 is judged as an instruction to shutdown the operation when the work is terminated in Step 137, proceed to Step 138, designate all paper discharging trays 20a-20n into which paper P are discharged as the shunting trays, and execute the shunting work of the trays 20a-20n according to the fourth flowchart in Step 140. Then, proceeding to Step 141, turn off the power source of the digital composite apparatus 10 and terminate all operations. At this time, the “DEFAULT” set conditions are cleared.

When the operating instruction to the sorter 11 in Step 112 is other processes in Step 142 or when there is no operating instruction to the sorter 11 in Step 112, proceeds to Step 143. When there are paper P reached the set forced shunting time in Step 143, designate the discharging tray reached the forced shunting time as the shunting tray in Step 144, execute the shunting work of the trays 20a-20n according to the fourth flowchart in Step 144 and proceed to Step 150. When there is no paper P reaching the set forced shunting time in Step 143, proceed to Step 147. When users take up the paper, record a time of the paper P from the discharge to the take-up as a shunting time in a memory (pot shown) of the CPU 30 in Step 148 and execute the rearranging work of the trays according to the second flowchart in Step 150.

When the forced shunting advance notice setting is ON in Step 151, proceeds to Step 152 and when the forced shunting advance notice setting is OFF, returns to Step 107. In Step 152, when there are paper P that are over the time of forced shunting advance notice, a specified user is notified in advance of that a forced shunting time comes soon in Step 153 and returns to Step 107. When there is no paper P that passed the time of forced shunting advance notice in Step 152 and the number of remaining empty trays is few, a user who has the most short time to the forced shunting time is notified of the possibility for the forced shunting and returns to Step 107. When many empty trays remain in Step 154, returns to Step 107.

When the paper discharging mechanism is constructed as described above, new paper P of image forming job discharged from the digital composite apparatus commonly used by many users can be always stored the paper discharging trays 20a-20n of upper stages when first storing them in the discharge trays 20a-20n and users are able take up paper P easily. Furthermore, when paper P elapsed the forced shunting time and retained in the discharging trays for a long time or the discharging trays 20a-20n are fully filled or are close to the full state, paper P that are retained for the most long hour are taken out of the lowest paper discharging stage tray 20n and an empty tray can be secured in upper paper stages of the discharging tray unit 20. Therefore, the digital composite apparatus 10 is not forced to wait the paper discharge for the retention of paper P for a long period in the discharging trays 20a-20n and it becomes possible to realize a large capacity without impeding the high speed digital composite apparatus 10.

Furthermore, the shunting work of paper P that was so far depending on users can be executed without troubling users and the workload for controlling the sorter 11 is reduced and operability of user side is promoted. In addition, the advance notice to users before the shunting work has an effect to have users recall the take-up of own paper and urge to pick up the paper.

Further, FAX paper or user designated paper taken out from the discharging trays 20a-20n during the shunting work are separated and transferred into the control box 22 separate from the shunting box subject for discard and therefore, required paper P will not be erroneously discard. Further, a user is ale to direct the shunting work of an image forming job that was made by himself and when the shunting work becomes necessary, it is possible to quickly cope with. So, the state of unnecessary paper accumulating in the trays 20a-20n can be effectively solved and the empty trays 20a-20n can be efficiently secured. Further, the setting conditions can be changed by a managing person or end users and operability is further promoted.

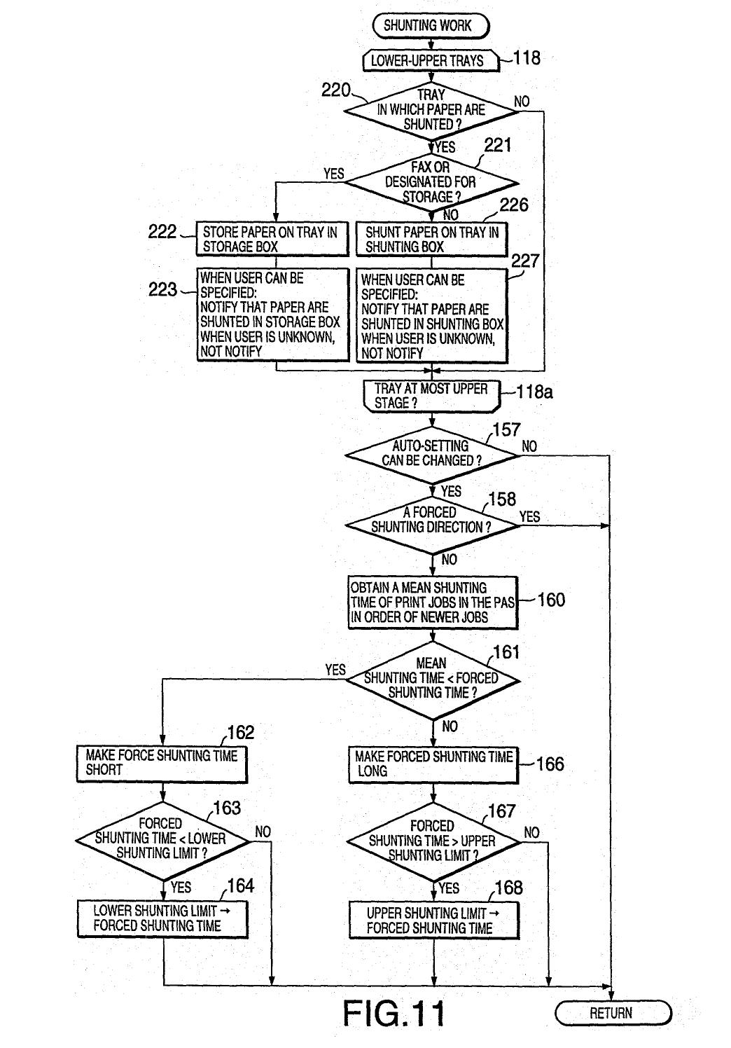

Next, this invention will be explained referring to a second embodiment shown in FIG. 11. The second embodiment is further given the function to the first embodiment for changing the forced shunting time according to actual using state of the digital composite apparatus 10 and the sorter 11 and other portions are the same as the first embodiment. Therefore, the same component elements explained in the first embodiment are assigned with the same reference numerals and the detailed explanation thereof will be omitted.

For the effective use of the paper discharging trays and reducing a time for user to search own paper from the shunting box, the fully filled state of the trays is best. However, a time is needed for rearranging the trays and if the trays are always full, in addition to the printing time, a time for rearranging the trays also becomes a burden on users.

In this second embodiment, a time required from the discharge of paper P by an image forming job to the shunting of paper P for the full state of the discharging trays 20a-20n is expected variable depending on the using date and time of the digital composite apparatus 10 and the sorter 11. Therefore, a forced shunting time of paper P is changed corresponding to the change in the required time.

When the shunting work is generated frequently for the full state of the discharging trays 20a-20n according to the currently set forced shunting time, change the forced shunting time short. On the other hand, when almost all shunting works are generated for the elapse of the forced shunting time before the discharging trays 20a-20n become full, change the set forced shunting time long. Further, record a time required for a user to take up paper P after discharged as a shunting time and when a mean time of the shunting times is extremely shorter than the currently set forced shunting time, change the forced shunting time short. On the other hand, when the mean time of the shunting time is extremely longer than the currently set forced shunting time, change the set forced shunting time longer so as to avoid the state wherein users are always needed to look own paper in the shunting box 23. Further, when the set forced shunting time was changed, the set shunting time is cleared whenever the power is turned off at the time when the work is terminated.

Next, the above-mentioned forced shunting time setting change will be described further in detail referring to the fifth flowchart shown in FIG. 11. This setting change is executed according to the shunting work routine described in Steps 117, 134, 140 or 146 as described in the first embodiment. That is, other steps are the entirely same as those in the first through third flowcharts of the first embodiment but the shunting work shown in the fourth flowcharts differs from the first embodiment.

When the scanning up to the top discharging tray is completed in Step 118a of the fifth flowchart, proceed to Step 157. If the automatic setting change was impossible in Step 157, terminate the shunting work and if it was possible, proceed to Step 158. When the forced shunting direction is confirmed in Step 158, terminate the shunting work and when no forced shunting direction is confirmed, proceed to Step 160 and obtain a mean shunting time from total shunting times required for every image forming job recorded in Step 148 of the first flowchart shown in FIG. 7.

When a mean shunting time is shorter than the forced shunting time in Step 161, make the forced shunting time short in Step 162. However, when the forced shunting time is shorter than the shunting lower limit in Step 163, make the shunting lower limit to the forced shunting time in Step 164. When the forced shunting time is longer than the shunting lower limit in Step 163, terminate the shunting work. When a mean shunting time is longer than the forced shunting time in Step 161, make the forced shunting time longer in Step 166. However, when the forced shunting time is longer than the shunting upper limit, make the shunting upper limit to the forced shunting time in Step 168. When the forced shunting time is shorter than the shunting upper limit in Step 167, terminate the shunting work.

After completing the shunting work by changing the forced shunting time as described above, return to Steps 128, 136, 141 or 150 of the first flowchart.

When the paper discharging mechanism is constructed as described above, in addition to the same effect as the first embodiment described above, the generation of empty discharging trays caused for paper P retained in the discharging trays 20a-20n for a long time can be-surely prevented when proper forced shunting times are set by considering the using state of the digital composite apparatus 10 changing according to using date and time and paper P pick-up state by users. Accordingly, it is surely possible to prevent such a phenomenon that the digital composite apparatus 10 is forced to wait-to discharge paper because there is no empty discharging tray and the disturbance for achieving the high speed of the digital composite apparatus 10 can be surely eliminated. Further, when picking up paper P, the number of operations to search the inside of the shunting box 23 can be reduced and operability can be promoted.

Further, this invention is not limited to the embodiments described above but can be modified without departing from the spirit and scope thereof. For example, the paper housing device can be used optionally and when the same user executes different image forming jobs at the continuous timing though but it may be so controlled that paper are discharged in the same paper housing device to secure many empty capacity by discharging paper in the same paper discharging trays without using a different paper discharging tray for each image forming job. Further, the control of a paper moving device b the controller is also not limited and for example, it is optional to perform the shunting work only when plural paper discharging trays are full without performing the shunting work at a specified shunting time. In addition, the arrangement of the accumulating devices and the construction of the paper moving device are also not limited.

As described above, according to this invention, in the case of a paper discharging mechanism of an image forming apparatus, which is a digital composite apparatus commonly used by plural user, image formed paper by new image forming jobs are always housed in the upper stage of paper discharging trays, paper housed in the paper discharging trays are shunting processed in order from those paper stayed for long hours in the paper discharging trays, and empty paper discharging trays are thus secured. Accordingly, it is possible to prevent the image forming apparatus from being forced to wait the paper discharging for the reason that the paper discharging trays are full and it is possible to achieve a large capacity without impeding an intention to spped up the image forming apparatus. Further, the manual paper shunting work by users becomes unnecessary, workload for managing the paper discharging mechanism can be reduced and thus, operability is improved.

What is claimed is:

1. A paper discharging mechanism of an image forming apparatus comprising:
paper discharging trays at plural stages to house paper on which images are formed by an image forming apparatus in upper stages in order from new image forming jobs;
accumulation device to accumulate the paper discharged from the paper discharging trays at plural stages;
a paper moving device to take out the paper housed in the paper discharging trays at plural stages and move into the accumulation device; and
a controller to control the paper moving device so as to take out the papers from the paper discharging trays in order from the older image forming jobs.

2. A paper discharging mechanism of an image forming apparatus according to claim 1, wherein
the paper discharging trays at plural stages are equipped with a paper falling device to bring the paper to paper discharging trays of lower stages in order.

3. A paper discharging mechanism of an image forming apparatus according to claim 2, wherein
the controller controls the paper moving device so as to take out the paper which are stayed in the most long hours in the paper discharging trays at plural stages after passed a specified time.

4. A paper discharging mechanism of an image forming apparatus according to claim 2, wherein
the controller controls the paper moving device so as to take out the paper that are housed in the most low stage of paper discharging tray of the paper discharging trays at plural stages after a specified time is elapsed.

5. A paper discharging mechanism of an image forming apparatus according to claim 2, wherein
the controller controls the paper moving device so as to take out the paper that are stayed for the most long hour in the paper discharging trays at plural stages when the paper are discharged in the most upper paper discharging trays of the paper discharging trays at plural stages in the image forming jobs by the image forming apparatus.

6. A paper discharging mechanism of an image forming apparatus according to claim 2, wherein
the controller controls the paper moving device so as to take out the paper discharged in the most low stage of the paper discharging trays at plural stages in the image forming job by the image forming apparatus.

7. A paper discharging mechanism of an image forming apparatus according to claim 2, wherein
the controller controls the paper moving device so as to take out all the paper discharged into the paper discharging trays at plural stages when completing all the image forming jobs of the image forming apparatus.

8. A paper discharging mechanism of an image forming apparatus according to claim 1, wherein
the accumulation device comprises a storage/accumulation device to store/accumulate the paper requiring storage and a shunting/accumulating device to accumulate the paper of lower importance.

9. A paper discharging mechanism of an image forming apparatus according to claim 8, wherein
the image forming job comprises a telephone line job that is executed according to image data from the telephone line and a network job that is executed according to image data from the network line, and the storage/accumulation device accumulates the paper containing images formed according to the telephone line job and the shunting/accumulating device accumulates the paper containing image formed according to the network job.

10. A paper discharging mechanism of an image forming apparatus according to claim 9, wherein
the paper discharging trays at the plural stages are equipped with a paper falling device to bring the paper housed in the paper discharging trays of upper stages in order into the lower stages of paper discharging trays.

11. A paper discharging mechanism of an image forming apparatus according to claim 10, wherein
the controller controls the paper moving device; so as to take out the paper housed in the paper discharging tray of the lowest stage and move into either the storage/accumulating device or the shunting/accumulating device after a specified time is elapsed.

12. A paper discharging mechanism of an image forming apparatus according to claim 10, wherein
the controller controls the paper moving device so as to take out the paper housed in the paper discharging tray of the lowest stage out of the paper discharging trays at plural stages and move into either the storage/accumulating device or the shunting/accumulating device in the image forming job by the image forming apparatus.

13. A paper discharging mechanism of an image forming apparatus according to claim 10, wherein
the controller controls the paper moving device so as to take out the paper housed in the paper discharging tray of a specified stage out of the paper discharging trays at plural stages accordin to the direction from the network line and move into the shunting/accumulating device.

14. A paper discharging mechanism of an image forming apparatus according to claim 10, wherein
the controller controls the paper moving device so as to take out all the paper housed in the paper discharging trays at plural stages and moves either to the storage/accumulating device or the shunting/accumulating device when completing all of the image forming jobs of the image forming apparatus.

15. A paper discharging mechanism of an image forming apparatus comprising:
paper discharging trays at plural stages to house paper on which images are formed by an image forming apparatus in upper stages from newer image forming jobs;
an accumulation device to accumulate the paper discharged from the paper discharging trays at plural stages;
a paper moving device to take out the paper housed in the paper discharging trays at plural stages and move into the accumulation device; and
a controller to control the paper moving device so as to take out the paper from the paper discharging trays in order from the older image forming jobs.

16. A paper discharging mechanism of an image forming apparatus according to claim 15, wherein
the paper discharging trays at plural stages are equipped with a paper falling device to bring down the paper in order into the paper discharging trays at lower stages.

17. A paper discharging mechanism of an image forming apparatus according to claim 16, wherein
the controller controls the paper moving device so as to take out the paper which are stayed in the paper discharging trays for the most long time after a specified time is elapsed.

18. A paper discharging mechanism of an image forming apparatus according to claim 16, wherein
the controller controls the paper moving device so as to take out the paper that are housed in the paper discharging tray of the lowest stage out of the paper discharging trays at plural stages after a specified time is elapsed.

19. A paper discharging mechanism of an image forming apparatus according to claim 16, wherein
the controller controls the paper moving device so as to take out the paper that are housed in the paper discharging tray at plural stages for the most long time when the paper are housed in the paper discharging tray of the most upper stage out of the paper discharging trays at plural stages in the image forming job of the image forming apparatus.

20. A paper discharging mechanism of an image forming apparatus according to claim 16, wherein
the controller controls the paper moving device so as to take out the paper that are housed in the paper discharging tray of the lowest stage out of the paper discharging trays at plural stages when the paper are housed in the paper discharging trays of the most upper stage out of the paper discharging tray of plural stage in the image forming job of the image forming apparatus.

21. A paper discharging mechanism of an image forming apparatus according to claim 16, wherein
the controller controls the paper moving device so as to take out all the paper housed in the paper discharging trays at plural stages when all of the image forming jobs of the image forming apparatus are completed.

22. A paper discharging mechanism of an image forming apparatus according to claim 15, wherein
the accumulation device comprises a storage box to accumulate the paper required storage and a shunting box to accumulate the paper of lower importance.

23. A paper discharging mechanism of an image forming apparatus according to claim 22, wherein
the image forming job comprises a telephone line job that is executed according to image data from a telephone line and a network job that is executed according to image data from a network line, and the storage box accumulates the papers with images formed thereon according to the telephone line job and the shunting box accumulates the paper with images formed thereon according to the network job.

24. A paper discharging mechanism of an image forming apparatus according to claim 23, wherein
the paper discharging trays at plural stages are equipped with a paper falling device to bring the paper housed in the upper stage paper discharging trays down into the lower stage paper discharging trays in order after a specified time is elapsed.

25. A paper discharging mechanism of an image forming apparatus according to claim 24, wherein
the controller controls the paper moving device so as to take out the paper housed in the most low stage paper discharging tray out of the paper discharging trays at plural stages and move in either the storage box or the shunting box.

26. A paper discharging mechanism of an image forming apparatus according to claim 24, wherein
the controller controls the paper moving device so as to take out the paper housed in the most low stage paper discharging tray out of the paper discharging trays at plural stages and move in either the storage box or the shunting box when the paper are housed in the most upper stage paper discharging tray out of the paper discharging trays of plural stage in the image forming job according to the image forming apparatus.

27. A paper discharging mechanism of an image forming apparatus according to claim 24, wherein
the controller controls the paper moving device so as to take out the paper housed in the paper discharging tray of a specified stage out of the paper dischaging trays at plural stages according to the direction from the network line and move in the shunting box.

28. A paper discharging mechanism of an image forming apparatus according to claim 24, wherein
the controller controls the paper moving device so as to take out all of the paper ho-used in the paper discharging trays at plural stages and move in either the storage box or the shunting box when all of the image forming jobs of the image forming apparatus are completed.
